(19) United States
(12) Patent Application Publication
(10) Pub. No.: US 2001/0032951 A1
(43) Pub. Date: Oct. 25, 2001

(54) BALL VALVE STEM SEAL ARRANGEMENT

(76) Inventor: ROBERT C. STEWART, NORTHFIELD CENTER, OH (US)

Correspondence Address: CALFEE HALTER & GRISWOLD, LLP, 800 SUPERIOR AVENUE, SUITE 1400, CLEVELAND, OH, 44114, US

(21) Appl. No.: 09/418,195

(22) Filed: Oct. 13, 1999

(51) Int. Cl. F16K 5/06

(52) U.S. Cl. 251/214; 251/175; 277/387; 277/403

(57) ABSTRACT

A ball valve having a ball-style closure member that is trunnion mounted in a valve body includes a stem seal and two backup rings that are axially disposed on the stem adjacent the seal. One of the backup rings includes a tapered face that seats against a tapered shoulder of the stem so that under pressure the backup ring is radially forced against a passageway wall in which the stem is disposed to prevent extrusion and to function as a load bearing surface. Alternatively, the backup ring can be compressed against the stem wall. The closure member may also include a plurality of low friction bearings disposed on the stem on opposite sides of the seal and backup ring assemblies, and may also include a trunnion bearing disposed on a lower trunnion of the closure member. The tapered backup ring is preferably made of a harder material, such as PEEK, compared to the material of the other backup ring which may be, for example, TEFLON™. The bearings may also be TEFLON™ or PEEK, for example. In one embodiment the stem seal is an o-ring.

### TECHNICAL FIELD OF THE INVENTION

The present invention relates to stem seals such as can be used, for example, with trunnion mounted ball valves, and more particularly to a stem seal arrangement that includes a plurality of stem seal backing rings to improve performance of the stem seal under pressure thereby increasing the valve cycle life.

### BACKGROUND OF THE INVENTION

Ball valves are well known to those skilled in the art. One design that has met with substantial commercial success is the 83 Series ball valve manufactured and sold by Swagelok Company and as described in U.S. Pat. Nos. 4,479,513 (hereinafter the “'513 patent”) and U.S. Pat. No. 4,572,239 (hereinafter the “'239 patent”) the entire disclosures of which are fully incorporated herein by reference. This ball valve design is characterized by a number of features that improve seal performance and cycle life of the valve.

In the '513 patent, the ball valve is described as having a stem seal arrangement of two basic configurations. In one embodiment illustrated in FIG. 5 of the '513 patent, the seal is realized in the form of a respective o-ring 54 disposed in a groove 50 in the upper and lower trunnions 42, 44. A backup ring 56 is used in association with each of the o-rings 54. In an alternative three-way valve configuration illustrated in FIG. 7 of the '513 patent, the seals 54 are positioned on a reduced diameter portion of the actuator stem, rather than on the trunnions. A close tolerance is used between the valve stem body 180 and a central passageway 26 of the bonnet 22. This close tolerance is used among other things to contain the stem seal and thereby ensure a good seal between the valve stem and the valve body. Trunnion wear is reduced by the use of a low friction coating applied to the surface of the trunnions, such as, for example, a thin layer of TEFLON™.

It is therefore an objective of the present invention to provide additional design features to further improve the performance of valves of the general type that use a stem seal under pressure while maintaining or increasing the cycle life of the valve.

### SUMMARY OF THE INVENTION

To the accomplishment of the foregoing objectives, and in accordance with one embodiment of the invention, a ball valve includes a valve body having a central passageway extending therethrough with a valve actuator stem of a trunnion mounted ball disposed in the passageway and mounted for selective rotation between valve open and valve closed positions to control fluid flow through the valve. The stem seal concept of the present invention can be applied, however, to many other valve designs other than ball valves or trunnion mounted valves. In accordance with one aspect of the invention, the valve stem includes a groove with a seal disposed therein along with first and second backup rings.

In accordance with another aspect of the invention, a first one of the backup rings is disposed axially adjacent the seal to prevent seal extrusion when the seal is exposed to operating pressure. The second backup ring is disposed axially adjacent the first backup ring and prevents extrusion of the first backup ring into a gap between the valve stem and the wall of the central passageway. It is preferred though not required that the second backup ring be made of a harder material than the first backup ring. For example, the second ring may be made of PEEK material while the first backup ring may be made of TEFLON™ material. Other materials compatible with the fluid flowing through the valve and with operating temperatures and pressures may alternatively be used for the backup rings.

In accordance with another aspect of the invention, the second backup ring includes a taper that causes the ring to expand radially outward into engagement with the central passageway wall to prevent extrusion of the first backup ring and also to function as a load bearing surface to stabilize and reduce wear of the stem. Alternatively, the taper can be used to cause the ring to compress inwardly to form an ID seal against extrusion. In accordance with another aspect of the invention, preferably but not necessarily the second backup ring is split to allow for radial expansion of the ring when the ring is made of harder material.

In accordance with another aspect of the invention, either or both of the trunnions are provided with low friction bearings to reduce galling and wear of the trunnions.

These and other aspects and advantages of the present invention will be apparent to anyone skilled in the art from the following description of the preferred embodiments in view of the accompanying drawings.

### BRIEF DESCRIPTION OF THE DRAWINGS

The invention may take physical form in certain parts and arrangements of parts, preferred embodiments and a method of which will be described in detail in this specification and illustrated in the accompanying drawings which form a part hereof, and wherein:

FIG. 1 is a cross-sectional view of a ball valve that incorporates the concepts of the present invention;

FIG. 2 is an enlarged view of the stem seal arrangement of the embodiment of FIG. 1;

FIG. 3 illustrates an alternative embodiment of a stem seal arrangement in accordance with the present invention;

FIG. 4 illustrates another embodiment of a stem seal arrangement in accordance with the present invention;

FIG. 5 is a first embodiment of a trunnion low friction bearing concept;

FIG. 6 illustrates an alternative embodiment for a low friction trunnion bearing in accordance with the invention;

FIGS. 7A and 7B illustrate in partial cross-section and in a simplified manner how the stem seal concept of FIG. 1 works in a typical application; and

FIG. 8 illustrates an alternative stem seal arrangement for sealing ID gaps.

### DETAILED DESCRIPTION OF THE PREFERRED EMBODIMENTS

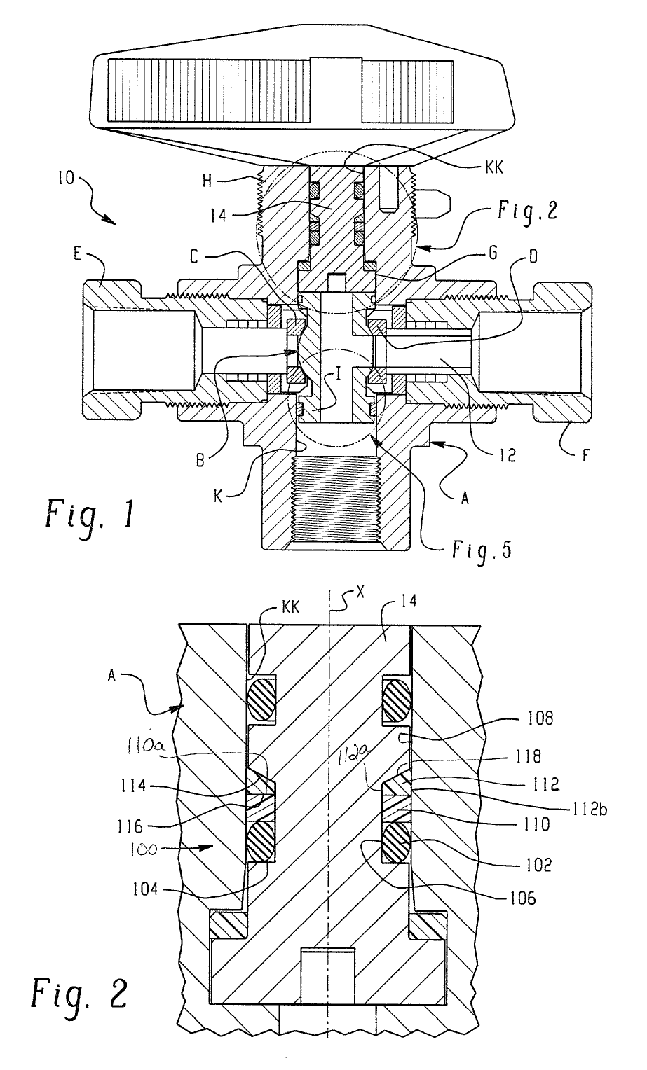

With reference to FIGS. 1 and 2, a valve assembly is generally indicated by the reference numeral 10. The valve assembly 10 in this exemplary embodiment is a trunnion mounted ball design in which a ball type closure member is captured between two flexible seat rings, such as, for example, the ball valve design illustrated and described in the '513 and '239 patents. Reference to the detailed disclosures of those patents will provide a thorough understanding of the valve design and operation. The present disclosure is directed to the stem seal design features of any valve of the general type that uses stem seals and for other aspects of the invention for trunnion style valves. The stem seal concepts and the trunnion concepts of the present invention can be used together in a valve or can be used alone. A detailed explanation of the valve design and operation is not required to understand and practice the present invention; however, the '513 and '239 patents may be referred to for such detailed explanation. Those of ordinary skill in the art will appreciate, however, that the stem seal concepts of the present invention can be applied to other valve configurations besides a trunnion mounted ball valve as set forth in the exemplary embodiments herein, and further that the stem seal and trunnion bearing improvements described herein will have application to other ball valve designs and are not limited to use with a ball valve such as the valve designs that are described in the '513 and '239 patents.

With reference to FIG. 1 then, the ball valve assembly 10 includes a valve body A with a closure member B disposed in a central passageway 12 in the valve body A. In this example, the closure member is realized in the form of a ball member B. The ball member B is mounted for selective rotation between a valve open position as illustrated in the various views, and a valve closed position (not shown). A pair of seat assemblies C and D are provided in the central passageway 12 on opposite sides of the ball member B. The ball member B and the seat assemblies C and D are enclosed within the valve body A by a pair of opposed end fittings E and F. The end fittings E and F are mounted to the valve body A by any convenient arrangement, in this example by a threaded engagement between the fittings and threaded bores in the valve body.

The closure member B is a trunnion mounted ball assembly as described in the above referenced patents. The upper trunnion G is disposed in a central passageway K through a bonnet H of the valve body. A lower trunnion I is disposed below the ball member in a lower portion of the central passageway K in the bonnet H. Although the exemplary embodiments herein illustrate a three way valve configuration, those of ordinary skill in the art will readily appreciate that the invention can be realized in a conventional two way valve configuration. A stem portion 14 extends axially from the upper trunnion G and is of a reduced diameter compared to the trunnion diameter. The stem 14 is disposed in a reduced diameter portion KK of the central passageway K in the bonnet H.

In accordance with a first aspect of the invention and with reference to FIG. 2, a stem seal arrangement 100 is provided that permits a larger gap between the stem 14 and the valve body A as compared to previous valve designs. This larger spacing reduces galling and wear of the stem 14 by minimizing contact between the stem 14 and the valve body A, thus increasing the cycle life of the valve. For example, the spacing in the present design may be on the order of about 0.03 inches, while in the previous designs the spacing may have been on the order of about 0.01 inches. As will be apparent from the further description herein, the present invention accommodates this larger gap between the stem 14 and the valve body A by the use of the improved stem seal arrangement that provides both improved seal protection under pressure and a load bearing function.

The stem seal arrangement 100 includes a stem seal 102, which in the preferred embodiment is realized in the form of an o-ring made of a suitable material such as Viton™ or buna, to name just two of many examples well known in the art. The material for the o-ring 102 will be selected based on compatibility with the fluid passing through the valve, as well as other operational criteria such as temperature and pressure ratings. A seal 102 geometry other than an o-ring may also be used as will be readily apparent to those of ordinary skill in the art.

The stem seal 102 is disposed in a circumferential groove 104 formed in the stem 14. The seal 102 is thus radially compressed between a groove wall 106 of the stem groove 104 and a wall portion 108 that defines the reduced diameter portion KK of the central passageway K in the bonnet H.

A first backup ring 110 is disposed in the stem groove 104 adjacent the seal 102 and axially supports the seal 102 after the valve is assembled. This first backup ring 110 is preferably made of a low friction material, such as TEFLON™, for example. This first backup ring 110 engages both the body wall 108 and the stem groove wall 106 and functions as a backup for the seal 102. As a backup for the seal 102, the first backup ring 110 functions to prevent the seal 102 from extruding under pressure and/or temperature along the groove wall 106 and along the wall 108 of the central passageway KK.

A second backup ring 112 is disposed in the groove 104 axially adjacent the first backup ring 110. The second backup ring 112 has an axially extending and generally cylindrical inner wall 112a and an axially extending generally cylindrical outer wall 112b. The second backup ring 112 preferably includes a radially contoured surface, in this embodiment in the form of a tapered or chamfered surface 114. The tapered surface 114 is axially spaced from a radial end wall 116 of the second ring 112. The end wall 116 is in contact with the first backup ring 110. In this embodiment, the end wall 116 is generally planar and abuts a generally planar end wall 110a of the first backup ring 110. The tapered surface 114 is more preferably but not necessarily frusto-conical in shape and seats against a preferably but again not necessarily conforming tapered wall or shoulder 118 of the stem 14.

The tapered surface 114 of the second backup ring 112 extends between the inner and outer cylindrical walls 112a, 112b of the ring 112. The surface 114 tapers axially with respect to the longitudinal axis X of the stem 14, and is tapered with an increasing radial dimension in a direction away from the source of fluid pressure in the valve. The tapered shoulder 118 of the valve stem 14 that contacts the second backup ring 112 is also axially tapered with an increasing radial dimension away from the source of fluid pressure.

With this arrangement, fluid pressure applies a force on the seal 102 (in FIG. 2 the fluid pressure would be present from below the seal arrangement 100 as viewed in FIG. 2 and the other Figures as well) that tends to push the first backup ring 110 away from the pressure (upward as viewed in FIG. 2). The first backup ring 110 pushes on and forces the second backup ring 112 upward. Because of the tapered surface 114, the second backup ring 112 will tend to be pressed radially outward or in other words will radially expand outwardly against the wall 108 of the central passageway KK. This outward radial expansion presses the outer cylindrical wall 112b of the second backup ring 112 against the wall 108. The increase in force of the second backup ring 112 against the wall 108 prevents the first backup ring 110 from extruding under pressure between the second backup ring 112 and the wall 108. The first backup ring 110 prevents extrusion of the o-ring 102 under pressure as noted hereinabove. The radial expansion of the second backup ring 112 is due to the fluid pressure exerting an axial force on the second ring 112. Under this axial force, the second ring tapered surface 114 is pressed against the tapered shoulder 118 of the stem 14 thereby displacing or expanding the second ring 112 radially outwardly.

Because the second backup ring 112 is used to contain and prevent extrusion of the first backup ring 110, preferably the second backup ring 112 is made of a relatively harder plastic material than the first backup ring 110. A suitable material is PEEK to name one example. Other suitable materials include, for example, Tetralon™ (a reinforced Teflon™), or a high durometer material such as is commonly used for o-rings (for example, a 90 durometer material such as Viton™ or buna).

Under pressure, the second backup ring 112 radially expands to close any gaps between the ring 112 and the stem passageway wall 108. By closing these gaps, the first backup ring 110 does not extrude under pressure, and thus will securely contain the seal 102 in place under pressure, thus maintaining seal integrity against fluid leakage. The radial expansion of the second backup ring 112 under pressure permits the valve to be designed with the larger gap between the stem 14 and the valve body A, more specifically the wall 108, as noted hereinabove. This increased gap reduces wear of the stem 14 thus increasing cycle life of the valve.

The radial expansion of the second backup ring 112 under pressure allows the second backup ring 112 to also function as a stem bearing under pressure. As noted, the second backup ring 112 is preferably made of a harder material such as PEEK, as compared to the material of the first backup ring 110. The harder material supports the side loads as a bearing better than the relatively softer material such as TEFLON™ of the first backup ring 110. The tapered surfaces 114 and 118 also operate to make the second backup ring 112 self-centering, and the OD support of the ring 112 as a bearing tends to stabilize the stem 14 when the valve is under pressure, thus reducing stem 14 wobble and wear.

The first backup ring 110 is used in the stem seal arrangement 100 because without the first backup ring 110, under pressure the seal 102 could extrude into any gap created between the inner diameter of the tapered ring 112 and the groove wall 106. This gap can appear under pressure due to the radial expansion of the tapered ring 112. Extrusion of the seal 102 into a small gap can produce nibbling of the seal during pressure cycling. Thus, the second backup ring 112 prevents extrusion of the first backup ring 110 and the first backup ring 110 prevents extrusion of the seal 102. The entire seal arrangement 100 functions to maintain the seal integrity against fluid leakage between the stem and the valve body. Both backup rings contribute to this effect.

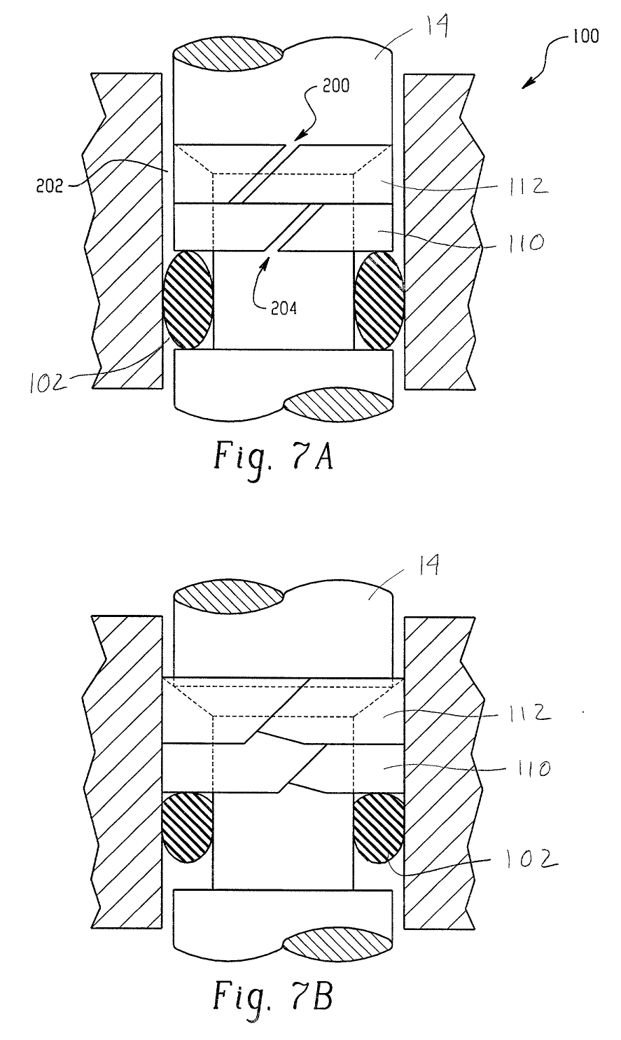

The second backup ring 112 is preferably installed as a split ring. As illustrated in FIG. 7A, the second backup ring 112 is preferably a split ring with a single cut 200. More preferably the cut 200 is formed at a forty-five degree (45°) angle. FIG. 7A illustrates the stem seal arrangement 100 under low or zero pressure, and FIG. 7B illustrates the seal arrangement 100 when the valve is under pressure. The cut 200 permits the second backup ring 112 to radially expand under pressure to close the OD gap 202. The angled cut 200 is used to minimize extrusion of the first backup ring 110 into the area of the split 200, and in practice the first backup ring 110 tends to compress the ring 112 axially to close any gap at the split 200. This prevents extrusion of the first backup ring 110 into the area of the split 200. The use of a split ring for the second backup ring 112 also makes the ring 112 easier to install on the stem 14. The first backup ring 110 may also be split as at 204 for ease of installation.

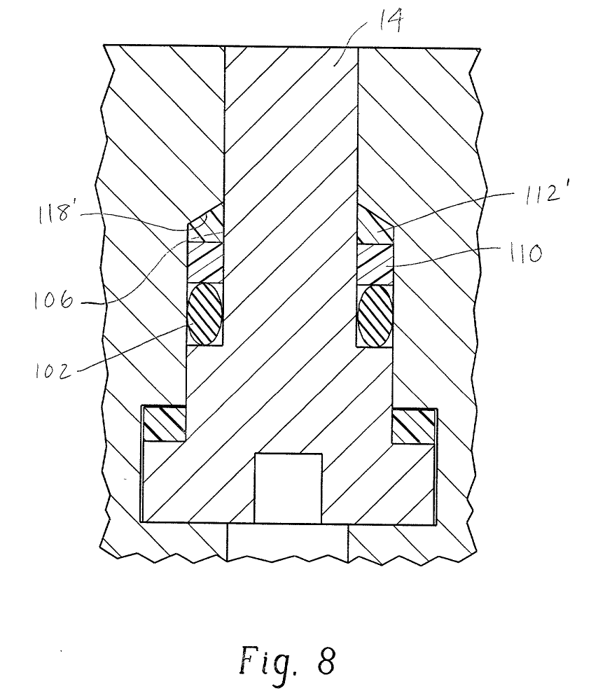

It should be noted that although the embodiment described herein illustrates a radial expansion of the second ring 112 to close an outer diameter (OD) gap at the wall 108, the tapered ring surface 114 of the second backup ring 112 could alternatively be axially tapered with a decreasing radial dimension away from the source of fluid pressure, as illustrated in FIG. 8. In this embodiment, rather than a tapered shoulder or chamfer on the stem 14, the body A is provided with a tapered shoulder 118′. In such an arrangement, fluid pressure that forces the second backup ring 112′ against the shoulder 118′ will cause the ring 112′ to be radially compressed inwardly to seal any inner diameter (ID) gaps along the stem wall 106.

It should further be noted that the second back up ring 112 could be made of a softer material that is radially squeezed outward as the ring 112 is forced against the tapered shoulder 118 of the stem 14. In other words, the second backup ring 112 does not necessarily have to include a tapered surface such as the surface 114, because the tapered shoulder 118 will tend to radially expand the ring 112 when the ring 112 is pressed against the shoulder 118 under fluid pressure.

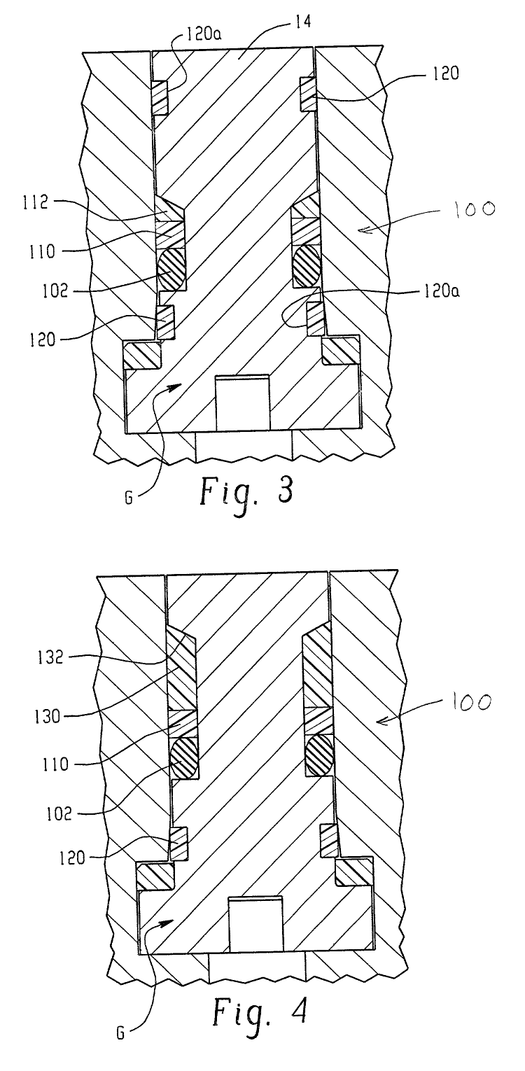

FIG. 3 shows the stem seal arrangement 100 along with a pair of low friction bearings 120 disposed axially on each side of the stem seal arrangement 100. These bearings 120 are disposed in respective circumferential grooves 120a formed in the stem 14, axially spaced from the seal arrangement 100. The bearings 120 preferably are made of a high load bearing material such as PEEK. The bearings 120 can be snap fit into the grooves 120a by sliding the bearings over the stem 14, or alternatively can be split rings that can be radially expanded to install the bearings 120 into their respective grooves 120a. In other exemplary alternatives, the bearings could be molded in place on the stem 14, or a snap ring could be used to hold the bearings on the stem 14.

FIG. 4 illustrates another embodiment of the present invention. In this example, the second backup ring 130 is axially longer compared to the backup ring 112 of the above described embodiment. The second backup ring 130 includes the tapered outer end 132, but due to its extended axial dimension can also serve as a stem bearing, thus obviating the need for the upper stem bearing 120 of FIG. 3. In all other respects the second backup ring 130 operates in a manner substantially the same as the above described embodiments herein.

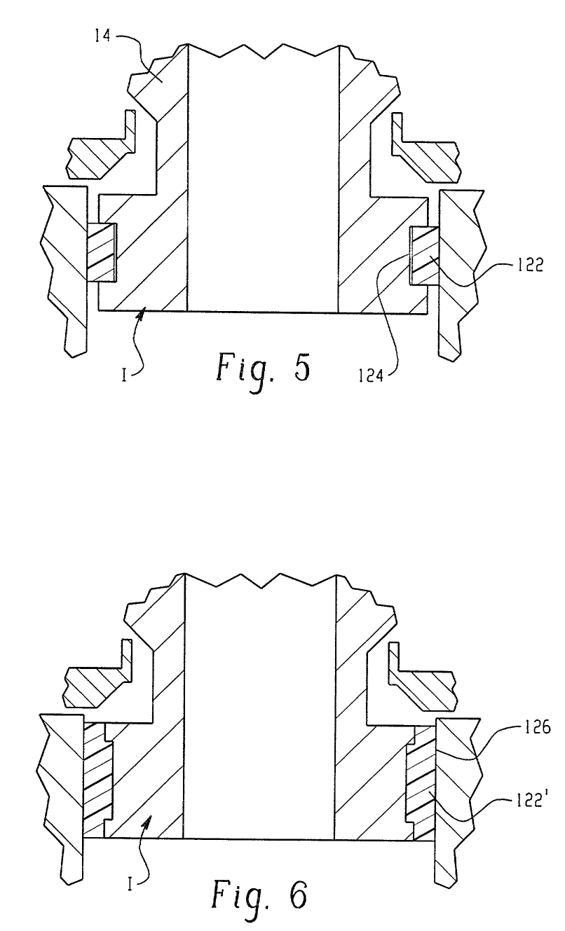

FIG. 5 illustrates the use of a trunnion bearing 122 on the lower trunnion I. The bearing 122 can be similar in material and configuration as the upper bearings 120 and is disposed in a respective trunnion groove 124. This bearing 122 replaces the TEFLON™ coated trunnion concept used in earlier valve designs, increasing wear resistance and substantially reducing galling. The bearing 122 simplifies rebuild since the bearing is removed with the ball assembly, and also compensates for trunnion and ball size variations. Again, the trunnion bearing 122 may be installed as a snap on bearing into the groove 124.

FIG. 6 illustrates an alternative configuration for the lower trunnion bearing 122′. In this embodiment, the bearing 122′ is “T” shaped in cross-section as illustrated. This configuration provides more positive location and support for the bearing 122′ during actuation of the valve. The T-shape bearing 122′ also provides a larger bearing surface area 126 across the entire axial length of the trunnion I as compared to the embodiment of FIG. 5. This increased surface area reduces stress on the bearing from side loads when the valve is under pressure because the side load forces are distributed across a larger surface area. This configuration may also be used as required for the upper stem bearings 120 of the valve.

The snap fit bearings 122, 122′ are easier to install compared to a conventional slip on bearing because a positive location is provided for the bearing on the trunnion I. Rebuild of the valve (e.g. replacement of the stem assembly) is easier because the bearing comes out with the ball and stem. In contrast, a pressed in bearing often needs to be dug out of the passageway with a pick or tool because a tight fit is needed to prevent the bearing from shifting.

The use of the trunnion bearings 122 and the backup ring 112 as a bearing can significantly increase the cycle life of the valve, either alone or when used together. When used together a ten fold improvement of valve cycle life has been achieved. The use of the second backup ring significantly increases the pressure performance of the stem seal and also significantly improves the stem cycle life for rotary type actuated valves.

The invention has been described with reference to the preferred embodiment. Obviously, modifications and alterations will occur to others upon a reading and understanding of this specification. It is intended to include all such modifications and alterations insofar as they come within the scope of the appended claims or the equivalents thereof.

Having thus described the invention, it is claimed:

1. A valve comprising:
a body having a passageway defined by a wall extending therethrough;
a valve stem disposed in said passageway to control fluid flow through the valve;
a stem seal on said stem for providing a fluid seal between said stem and said wall; and
at least two backup members disposed axially adjacent said stem seal;
said backup members producing an increasing force in response to increasing fluid pressure to contain said seal and prevent seal extrusion.

2. The valve of claim 1 wherein said backup members comprise first and second backup rings disposed in a groove on the stem.

3. The valve of claim 2 wherein said first backup ring is disposed on said stem axially adjacent said seal to contain the seal in said groove against fluid pressure.

4. The valve of claim 3 wherein said second backup ring is disposed on said stem axially adjacent said first backup ring to prevent extrusion of said first backup ring between said stem and said wall.

5. The valve of claim 1 wherein one of said second backup members functions as a stem bearing under pressure.

6. The valve of claim 1 wherein said stem includes a tapered surface to urge one of said backup members radially outward in response to fluid pressure acting on said seal.

7. The valve of claim 1 comprising a low friction bearing disposed on said stem and axially spaced from said backup members.

8. The valve of claim 7 comprising two bearings disposed on said stem and axially spaced on either side of said backup members.

9. The valve of claim 1 wherein said valve comprises a trunnion mounted ball member having first and second trunnions, said stem extending axially from an upper trunnion.

10. The valve of claim 9 comprising a bearing member disposed in a groove formed in a trunnion.

11. The valve of claim 10 wherein said bearing member snap fits into said groove.

12. The valve of claim 1 wherein said backup members comprise first and second backup rings disposed axially adjacent said stem seal; wherein one of said backup rings comprises a first and second face; said first face being adjacent the other of said backup rings, and said second face is axially tapered.

13. The valve of claim 12 wherein said stem comprises a tapered shoulder against which said tapered face of said one backup ring seat ring seats so that under force of fluid pressure said one backup ring is urged radially outward against said wall to prevent extrusion of said other backup ring and to function as a load bearing surface.

14. The valve of claim 1 wherein said body includes a tapered surface to urge one of said backup members radially inward in response to fluid pressure acting on said seal.

15. A stem seal assembly comprising:
a valve actuator stem wherein said stem has a tapered shoulder;
a stem seal disposable in a circumferential groove on said stem adjacent said shoulder; and
a plurality of backup rings disposable on said stem axially adjacent said seal and said shoulder.

16. The assembly of claim 15 wherein one of said backup rings includes a conical face.

17. The assembly of claim 16 wherein said stem comprises a tapered shoulder against which said conical face seats when the backup ring is installed on said stem.

18. The assembly of claim 15 comprising a plurality of low friction bearings disposable on said stem on either side of said seal and backup rings.

19. The assembly of claim 15 comprising two trunnions extending from opposite sides of a ball closure member on said stem, and a low friction bearing disposed on each of said trunnions.

20. The assembly of claim 15 wherein one of said backup members is tapered to generally conform with said tapered shoulder of the stem.

21. The assembly of claim 15 wherein said backup rings are split.

22. A trunnion mounted ball valve comprising:
a valve closure member having ball and two trunnions on either side of the ball and a valve actuator stem extending axially from a first of said trunnions;
and a plurality of trunnion bearings disposed in bearing grooves formed in said trunnions.

23. The apparatus of claim 22 wherein each bearing extends an axial length that coextends with the axial length of its associated trunnion.

24. The apparatus of claim 22 wherein said bearings are snap fit installed on said trunnions.

25. A closure member for a ball valve, comprising:
a ball member with a pair of mounting trunnions each on diametric sides of the ball; and
a trunnion bearing disposed in respective bearing groove formed in each said trunnion.

26. The closure member of claim 25 wherein each said bearing coextends the axial length of its associated trunnion.

27. A method for sealing a valve stem and valve body against fluid pressure, comprising the steps of:
disposing a stem seal between the stem and body;
disposing a first backup ring axially adjacent the stem seal; and
using fluid pressure to radially displace a second backup ring to prevent extrusion of said first backup ring.

28. The method of claim 27 comprising the step of using the second backup ring as a load bearing between the stem and valve body under pressure.

29. The method of claim 27 wherein fluid pressure is used to radially expand said second backup ring.

30. The method of claim 27 wherein fluid pressure is used to radially compress said second backup ring.

31. A valve comprising:
a body having a passageway defined by a wall extending therethrough;
a valve stem disposed in said passageway to control fluid flow through the valve;
a stem seal on said stem for providing a fluid seal between said stem and said wall; and
at least two backup members disposed axially adjacent said stem seal;
said backup members producing an increasing force in response to increasing fluid pressure to maintain seal integrity.
